(19) United States
(12) Patent Application Publication
(10) Pub. No.: US 2011/0208501 A1
(43) Pub. Date: Aug. 25, 2011

(54) FUNCTIONAL TEST GENERATION THROUGH MODEL INVERSION

(75) Inventors: Anand V. Yeolekar, Bangalore (IN); Ramesh Sethu, Bangalore (IN)

(73) Assignee: GM GLOBAL TECHNOLOGY OPERATIONS, INC., Detroit, MI (US)

(21) Appl. No.: 12/712,384

(22) Filed: Feb. 25, 2010

(51) Int. Cl. G06F 17/50; G06G 7/62

(52) U.S. Cl. 703/13

(57) ABSTRACT

A system and method for generating test cases includes a model inverter configured to generate an inverse of a model, a conversion module configured to convert a requirements specification into at least one output scenario and a model simulator configured to generate a test case that satisfies the requirements specification based on the inverse of the model and the at least one output scenario.

### BACKGROUND

1. Field of the Invention

This invention relates generally to test case generation and, more particularly, to functional test case generation using model inversion techniques.

2. Discussion of the Related Art

In general, a system development process includes a requirements development stage, a design and development stage and a verification stage. A requirement may be characterized as a documented need of how a particular product or service should perform. More particularly, a requirement may be referred to as a statement that identifies the necessary functionalities, attributes, capabilities, characteristics or qualities of a system. Requirements in the form of a requirements specification are used as inputs into the design stages of a system development process to design what elements and functions are necessary for a particular system.

Requirement specifications can be expressed using a variety of languages. These languages may be graphical or textual in nature and may include, without limitation, transition systems (e.g., state machines), event sequence charts (e.g., scenario or sequence diagrams) and structured English language. The system is implemented using software or hardware or both, often using interfaces implemented using sensors to sense the environment (including the user) inputs and actuators to control the hardware. In complex systems, particularly those in which safety is a primary concern, exhaustive testing and verification of the system, is required to ensure that the behavior of the system satisfies the requirements specification of the system.

A common approach to testing and verifying system is formal verification. Broadly, formal verification is the process of proving or disproving the correctness of intended algorithms underlying a system with respect to a formal specification (also referred to as a property), using a class of state space exploration methods.

Known formal verification methods are normally applicable only to the models of the system at the design stage, or to the software portion of the systems. Although theoretically possible, models for entire systems can be impossible to implement, or at best, be extremely large so that existing formal methods techniques cannot scale to tackle the resulting large state space. Therefore, testing using simulation of the system is the only way of verifying the system against its requirements specification. However, since the test cases (i.e., test inputs to the system designed to produce the desired outputs) are written by testers, they usually test only simple specifications. This is because writing test cases for complex temporal specifications is error-prone. In addition, checking the simulation runs against the desired outputs according to complex temporal specifications is also time consuming and error-prone.

Thus, there is a need to provide a system and method for automatically generating test cases that is scalable to any size system.

### SUMMARY

A system and method for generating test cases includes a model inverter configured to generate an inverse of a model, a conversion module configured to convert a requirements specification into at least one output scenario and a model simulator that simulates the inverted model to generate a test case that satisfies the requirements.

Additional features of the present invention will become apparent from the following description and appended claims, taken in conjunction with the accompanying drawings.

### BRIEF DESCRIPTION OF THE DRAWINGS

FIG. 1 illustrates an exemplary test case generation system, according to one embodiment;

FIG. 2 is a flow chart illustrating an exemplary model inversion algorithm according to the test case generation system of FIG. 1; and

FIGS. 3a and 3b illustrate a non-limiting example of an inverse construction of an exemplary model M consistent with the inversion algorithm described in FIG. 2.

### DETAILED DESCRIPTION OF THE EMBODIMENTS

The following discussion of the embodiments of the invention are a system and method for functional test case generation using model inversion techniques. The aforementioned embodiments are merely exemplary in nature, and are in no way intended to limit the invention, its applications or uses.

The disclosed embodiments provide a scalable, computationally inexpensive system and method for automatic test case generation using model inversion techniques. In system design, a model may represent a system or program that interprets the functionality of the system being designed. The test case generation system disclosed herein includes a test case generator configured to generate test cases that satisfy a particular coverage metric based on the model and a requirements specification. The test case generator includes a model inverter module and a conversion module configured to convert a requirements specification into output scenarios. The inverse model from the inverter module and the output from the conversion module are fed as inputs to a model simulator, whose simulation output is a test case that satisfies the coverage metric.

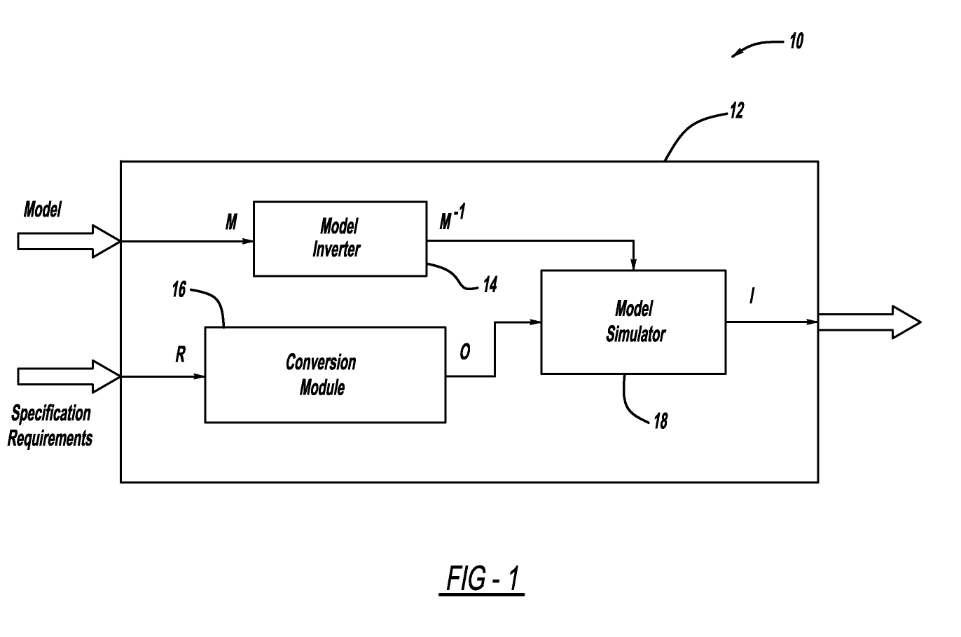

FIG. 1 illustrates an exemplary test case generation system 10 having a test case generator 12 that includes a model inverter 14, a conversion module 16 and a model simulator 18, such as, but not limited to, Matlab™. In one embodiment, the model inverter 14 is implemented on-line and is configured to receive a model or block of a model M and produce in response the model's inverse M⁻¹. However, since the inverse construction of the model needs to be done only once, the conversion may be implemented off-line. The conversion module 16 is configured to receive functional specification requirements R and produce in response an output signal O that represents the expected output of the model M. In one embodiment, the output signal O is a waveform, but one of ordinary skill in the art understands that the conversion module 16 may be configured to produce output signals O in varying formats. The model simulator 18 is configured to receive as inputs the model inverse M⁻¹ from the model inverter 14 and the output signal O from the conversion module 16, which represents the expected output scenario for the particular model or model block M being input into the test case generator 12. The model simulator 18 simulates the model inverse M⁻¹ and the output signal O to produce a test case representing the inputs to the model M that satisfy a set of predetermined criteria (i.e., coverage metric). In other words, the test case generator 12 finds inputs (i.e., test cases) for arbitrary output scenarios that satisfy the model M given a coverage metric C. In one example, coverage metric C, represented graphically, is a triangular wave having an output signal starting at some value V that increases in magnitude over time at a constant rate R, reaches a threshold T, then decreases at the same rate R. Illustrated graphically, this triangular wave represents the requirement (or coverage metric). The question is “can the system output a triangular signal with a rate of change R?” The test case generation system then tries to produce test inputs to satisfy this requirement by simulating the inverse model with the given triangular wave. The output of this simulation run is the required test vector.

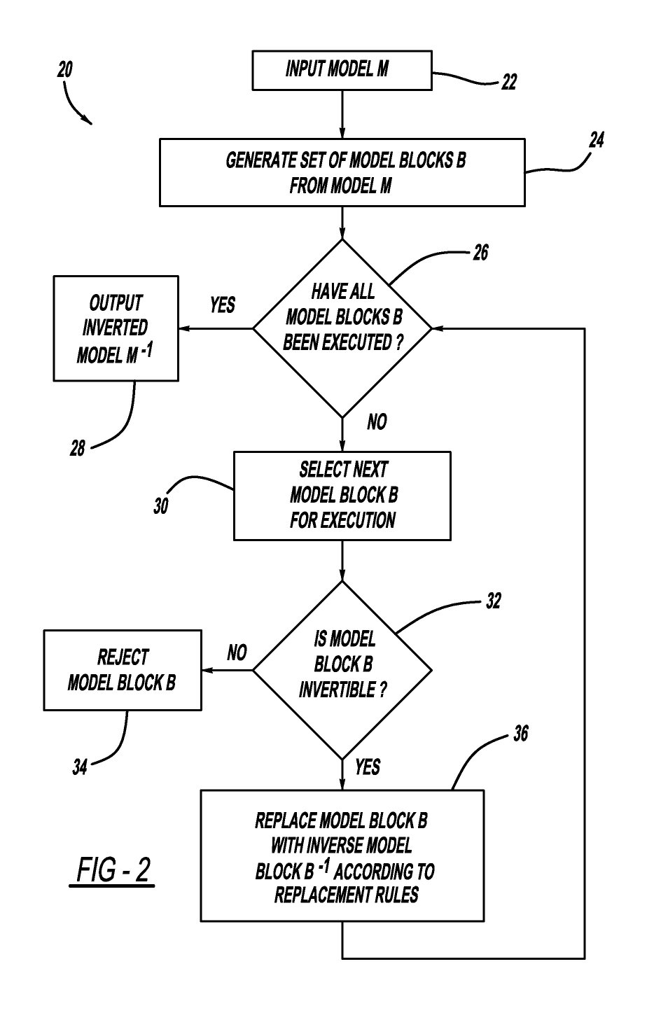

FIG. 2 is a flow chart illustrating an exemplary model inversion algorithm 20 according to the model inverter 14 of the test case generator 12 in FIG. 1. At step 22, a model M is input to the model inventor 14. At step 24, model M is separated into a set of model blocks B, wherein each model block B is processed by the algorithm 20 individually. At step 26, algorithm 20 determines if all model blocks B haven been processed. If so, then algorithm 20 outputs at step 28 the inverted model M⁻¹. If all model blocks B have not been processed, the next model block B is selected step 30. Next, at step 32, the algorithm 20 determines if model block B is invertible. If not, the model block B is rejected at step 34. If the model block B is invertible, model block B is replaced at step 36 by the model block inverse B⁻¹ according to a set of replacement rules, which may vary depending on the application. For example, using one approach an algorithm employing the replacement rules may instruct a gain block having a value of K to be replaced with a gain block having a value of 1/K. Similarly, a square block may be replaced with a squareroot block and a sine, cosine, and tangent function block may be replaced with an arcsine, arccosine and arctangent block, respectively. One of ordinary skill in the art also recognizes that a replacement algorithm may further include logic that provides a replacement selection if the standard replacement rules result in an error. For example, an error may result when a squareroot block receives a negative number as an input.

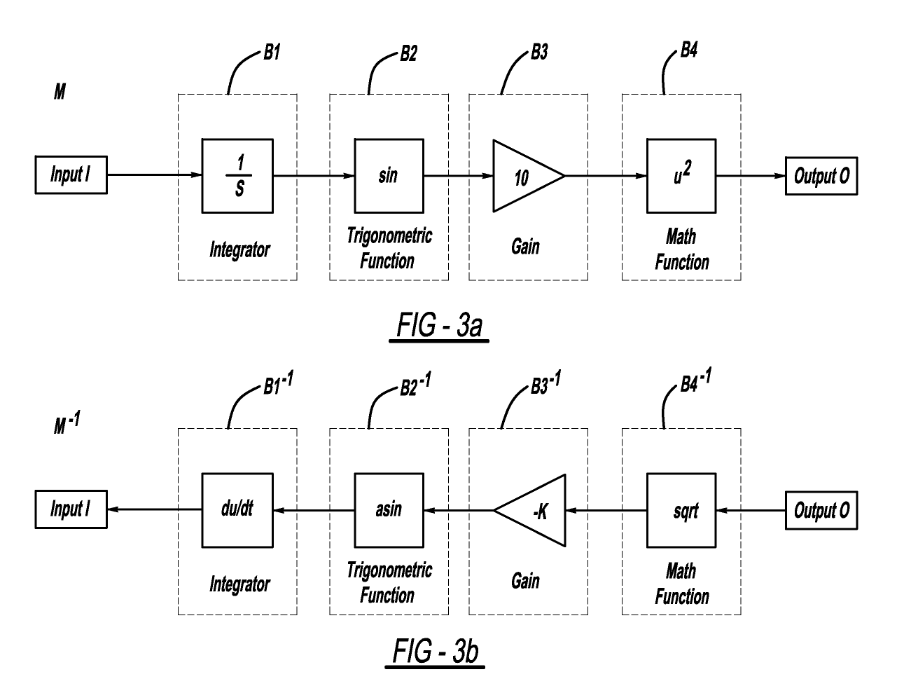

FIGS. 3a and 3b illustrate a non-limiting example of an inverse construction of an exemplary model M consistent with the inversion algorithm 20 described in FIG. 2. FIG. 3a illustrates an exemplary representation of a model M that is input into model inverter 14. In this example, model M includes model blocks B1, B2, B3 and B4, which represent an integrator function, a trigonometric function, a gain amplifier and a math function, respectively. As shown in FIG. 3b, the model inverter 14 converts model M in accordance with algorithm 20 to produce inverse model M⁻¹, which includes inverted model blocks B1⁻¹, B2⁻¹, B3⁻¹ and B4⁻¹. Specifically, each of the functions represented in the original model blocks are converted to their respective inverse functions. For example, the integrator of model block B1 is converted to its inverse function, a derivative; the trigonometric function sine in model block B2 is converted to its inverse arcsine; the gain amplifier in model block B3 is converted to a negative gain; and the squared variable function of model block B4 is converted to its inverse, the square root function.

Referring collectively to FIGS. 1, 3a and 3b, note that in FIG. 3a, the input to the model M is “Input I” and the output of model M is “Output O.” Using the approach described above, “Input I” to the model M is unknown, while “Output O” in FIG. 3a represents the known expected output scenario shown in FIG. 1 as the output of the conversion module 16. When the inverse model M⁻¹ of FIG. 3b is input into the model simulator 18 of FIG. 1, along with “Output O,” the result is “Input I,” which is the test case that satisfies the model M given a coverage metric C.

The system described herein may be implemented on one or more suitable computing devices, which generally include applications that may be software applications tangibly embodied as a set of computer-executable instructions on a computer readable medium within the computing device. The computing device may be any one of a number of computing devices, such as a personal computer, processor, handheld computing device, etc.

Computing devices generally each include instructions executable by one or more devices such as those listed above. Computer-executable instructions may be compiled or interpreted from computer programs created using a variety of programming languages and/or technologies, including without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable media includes any medium that participates in providing data (e.g., instructions), which may be read by a computing device such as a computer. Such a medium may take many forms, including, but not limited to, non-volatile media, volatile media, and transmission media. Non-volatile media includes, for example, optical or magnetic disks and other persistent memory. Volatile media include dynamic random access memory (DRAM), which typically constitutes a main memory. Common forms of computer-readable media include any medium from which a computer can read.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that further developments will occur in the arts discussed herein, and that the disclosed systems and methods will be incorporated into such further examples. In sum, it should be understood that the invention is capable of modification and variation and is limited only by the following claims.

The present embodiments have been particular shown and described, which are merely illustrative of the best modes. It should be understood by those skilled in the art that various alternatives to the embodiments described herein may be employed in practicing the claims without departing from the spirit and scope of the invention and that the method and system within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable construction and their ordinary meaning as understood by those skilled in the art unless an explicit indication to the contrary is made herein. In particular, use of the singular articles such as “a”, “the”, “said”, etc. should be read to recite one or more of the indicated elements unless a claim recites an explicit limitation to the contrary.

What is claimed is:

1. A system for generating test cases, the system comprising:
a model inverter configured to generate an inverse of a model;
a conversion module configured to convert a requirements specification into at least one output scenario; and
a model simulator configured to generate a test case that satisfies the requirements specification based on the inverse of the model and the at least one output scenario.

2. The system of claim 1, wherein the model inverter is configured to generate a set of model blocks based on the model.

3. The system of claim 2, wherein the model inverter converts each model block into an inverse model block.

4. The system of claim 3, wherein each model block includes a function and wherein each inverse model block includes a respective inverse function.

5. The system of claim 2, wherein the model inverter converts each model block into an inverse model block using a set of replacement rules.

6. The system of claim 1, wherein the at least one output scenario is an output waveform.

7. The system of claim 1, wherein the model inverter is configured to generate the inverse of the model on-line.

8. The system of claim 1, wherein the model inverter is configured to generate the inverse of the model off-line.

9. A method for generating test cases, the method comprising:
generating an inverse of a model;
converting a requirements specification into at least one output scenario; and
generating a test case that satisfies the requirements specification by simulating the inverse of the model using the at least one output scenario.

10. The method of claim 9, further including generating a set of model blocks based on the model.

11. The method of claim 10, further including converting each model block into an inverse model block using a set of replacement rules.

12. The method of claim 11, wherein each model block includes a function and wherein each inverse model block includes a respective inverse function.

13. The method of claim 9, wherein the at least one output scenario is an output waveform.

14. The method of claim 9, further including generating the inverse of the model on-line.

15. The method of claim 9, further including generating the inverse of the model off-line.

16. A system including a computer-readable medium tangibly embodying computer-executable instructions for:
generating an inverse of a model;
converting a requirements specification into at least one output scenario; and
generating a test case that satisfies the requirements specification by simulating the inverse of the model using the at least one output scenario.

17. The system of claim 16, further including generating a set of model blocks based on the model.

18. The system of claim 17, further including converting each model block into an inverse model block using a set of replacement rules.

19. The system of claim 18, wherein each model block includes a function and wherein each inverse model block includes a respective inverse function.

20. The system of claim 16, wherein the at least one output scenario is an output waveform.
